(19) United States
(12) Patent Application Publication
(10) Pub. No.: US 2025/0376637 A1
(43) Pub. Date: Dec. 11, 2025

(54) Formulation for producing a processing aid, method for producing a processing aid, and processing aid

(71) Applicant: DEVINOCHEM GmbH & Co. KG, Weisbaden (DE)

(72) Inventors: Florian Roth, Schlangenbad (DE); Falk Gabel, Schlangenbad (DE); Christian J. Barbe, Wiesbaden (DE)

(21) Appl. No.: 19/230,218

(22) Filed: Jun. 6, 2025

(30) Foreign Application Priority Data
Jun. 7, 2024 (DE) 102024115980.4

(51) Int. Cl. C11D 3/16; C11D 9/10; C11D 10/04

(52) U.S. Cl. CPC C11D 3/168; C11D 9/10; C11D 10/042

(57) ABSTRACT

The present disclosure generally relates to a formulation for producing a processing aid, such as a demolding agent or release agent, as used in particular in the production of rubber mixtures and other polymers as processing aids. More particularly, the present disclosure relates to a formulation for producing a processing aid which is produced in a more environmentally friendly manner than known processing aids, or at least can be produced in this manner, in particular using preferably at least 20% renewable raw materials. Furthermore, the present disclosure relates to a method for producing a processing aid and to the processing aid itself.

### TECHNICAL FIELD

The present disclosure generally relates to a formulation for producing a processing aid, such as a demolding agent or release agent, as used in particular in the production of rubber mixtures and other polymers as processing aids. More particularly, the present disclosure relates to a formulation for producing a processing aid which is produced in an even more environmentally friendly manner than known processing aids, or at least can be produced in this manner, in particular using preferably at least 20% renewable raw materials. Furthermore, the present disclosure relates to a method for producing a processing aid and to the processing aid itself.

In the context of this disclosure, a formulation refers a mixture of substances, for example as a precursor of a processing aid, which is converted into an application-compliant delivery form, and hence the processing aid, by the addition of a further component, preferably water, for example. This means that the formulation may, for example, come in the form of a powder, granules, or with a gel-like or paste-like consistency, which, however, is preferably still flowable and pumpable. Processing aids with a specific functional character may also be referred to as release agents, lubricants, anti-friction agents, anti-stick agents, demolding agents, product separation agents, or the like, depending on their character. These terms describe processing aids which are provided in a ready-to-use delivery form.

### BACKGROUND

As stated, the present disclosure generally relates to a formulation for producing a processing aid which can be used, for example, as a demolding agent or release agent. The processing aid according to the disclosure can be used, for example, in the form of a coating which acts like a release agent, and release agent is understood here to mean that it has the effect of keeping adjacent materials separable. In other words, the processing aid in this case can be understood as an agent with lubricant-like properties and can also generally be understood as a lubricant. Lubricants, or synonymously lubricating agents, are used for lubrication purposes and serve to reduce the sticking together or adhesion of surfaces to one another, hereinafter also referred to as adherence, but also to reduce friction and wear, and also for cooling purposes, for example by reducing frictional heat. The processing aid may also be implemented as a mold release agent or demolding agent, i.e. as a processing aid that prevents or at least reduces and/or minimizes the adhesion of cast and/or molded parts to the mold or, more generally, to a material that is used in the molding process. Furthermore, the processing aid according to the present disclosure can also act or be used as a lubricant, which is understood to mean in particular that it has a separating effect between surfaces or materials, which for example may also have an elevated temperature, for example so as to prevent a polymer melt from adhering to a hot metal surface such as the surface of a mold or of a tool. However, more generally, the processing aid can also be effective as a product release agent, for example as a product release agent that prevents the sticking of bulk material, granules and/or other preforms of a final product, in particular a polymeric final product. Generally, these aforementioned and subsequent specific embodiments are subsumed under the term “processing aid” in the context of the present disclosure, which can in particular be a processing aid that has a separating effect, which generally also refers to a product separating agent here under the general generic term of a processing aid, in particular a processing aid having a separating effect.

A specific embodiment of a processing aid within the meaning of the present disclosure can be understood as a demolding agent (synonym: release agent). The processing aid of the disclosure can be used, for example, as a processing aid in the manufacture of products from or comprising rubber mixtures and/or from or comprising other organic polymers. Processing aids in the form of demolding agents include, for example, agents which are applied to the surface of the product produced from or comprising a rubber mixture and/or produced from or comprising a polymer, or onto a mold that is used to produce the product. The film of processing aid applied is usually referred to as a release agent film. In the context of the present disclosure, this applied film can also be referred to and/or understood as a coating or layer. The purpose of the processing aid, for example of the demolding agent or release agent, is to prevent the produced product from adhering to the mold and/or to another similar product. It is also possible for the product to be in the form of a long strip which is stacked or rolled for storage, and in this case the different layers of the material should also not adhere to each other. This particular embodiment is mentioned here by way of example and represents a common embodiment or application of the processing aid according to the disclosure, so that many properties of the processing aid will be described further below with reference to this particular embodiment of the demolding or release agent. However, the application of the processing aid is by no means limited to this application, rather it can also be used in other areas, as explained in detail above.

Known processing aids, in particular prior art processing aids that have a release effect, expediently comprise an agent which can be applied to the surface of either the mold or the product itself, or optionally to both, and can act there as a separating body or spacer, thus preventing direct contact of the product with another product, with itself, and/or with the mold when the processing aid is used as a demolding or release agent. In the context of the present disclosure, “direct contact” is understood to mean physical contact between the surface of the product and another surface, for example that of a mold or of another portion of the product (for example another portion of a polymer sheet). Thus, the surfaces touch or come into contact with each other in the sense of the disclosure when they are in direct contact. This can be the case, for example, by applying a film made of or comprising the processing aid according to the disclosure to at least one of the surfaces in question. However, it is not absolutely necessary for the processing aid to be applied to at least one surface in the form of a coating and/or a film, rather it can also be applied to the surface in the form of a powder, for example. It is also possible that the processing aid is incorporated into the material of one of the surfaces, for example into the polymeric material. The effect of the processing aid, in whatever form it is applied, is intended to prevent the surfaces from adhering or sticking together. As a mechanism, it is generally assumed that at least one component of the processing aid acts as a spacer or separating body, which prevents or at least impedes physical and/or chemical bonding between the surface of the produced product and other surfaces that come into contact with the product. For example, known components of processing aids, such as for example demolding agents, are inorganic constituents such as silicates, in particular layered silicates, and/or chalk, which are used in particular in powdered or at least powder-containing processing aids. They act as a kind of mechanical spacer. The surfaces in question, which have such a processing aid, regardless of how it is provided, preferably react only in such a way with these surfaces and/or the material in question, thus in particular a polymer, that the physical properties of the material, in particular the polymer, are not changed. If these physical properties are nevertheless influenced, this is done in such a way that simple separation, for example of a product from a mold, is ensured and/or adhering of surfaces, for example polymer surfaces such as rubber surfaces, to each other can be prevented. In other words, the processing aid preferably influences the physical properties of the material, preferably the polymer, in particular a so-called “rubber,” with which it comes into contact and/or to which it is applied and/or in which it is incorporated, only in such a way that the surface properties, in particular the surface energy and/or the coefficient of friction, are changed while other properties remain unchanged.

In the context of the present disclosure, a powder is understood to be a delivery form which is essentially, i.e., preferably at least 60% by weight, or preferably at least 90% by weight or even more, or completely, composed of particles, wherein the term “particle” as used in this disclosure also comprises aggregates and agglomerates. The term powder component refers to inorganic phases as well as to organic phases or mixtures of organic and inorganic phases, which are preferably provided in particulate form. In the context of the disclosure, a powder component comprising inorganic phases or an inorganic phase is also referred to as a separator component, which is based on an inorganic phase and can be added as a powder component. These may be, in particular, layer silicates.

The processing aid, for example a processing aid comprising a separator component, which is based on an inorganic phase, is usually used in the form of a dispersion or suspension, for example a coarsely dispersed dispersion or a fine suspension, and is applied, for example, to a mold or to the surface of a manufactured product. This is particularly the case when referring to a release film. However, depending on the exact design of the process or the product produced, it is also possible that parts of the processing aid can be incorporated into the surface of the product or at least mixed into it in some areas. It may also be the case that the processing aid is first applied to a surface in the form of a film (or a coating), but remains on it and then is still present during further processing steps, thus remaining in the product or being mixed into it. It is also possible and known from the prior art that, in the case of a release film, i.e., a release agent in the form of a coating, this film or release agent is applied in such a way that it achieves its desired effect but is removed from the surface again as required depending due to the further and subsequent processing steps. This can be done, for example, by washing off with water.

At the same time, such processing aids comprising a separator component, which is based on an inorganic phase, have the benefit that the separator component, which is based on an inorganic phase, in particular if it is a silicate, for example a layer silicate, can perform further functions. For example, processing aids comprising such a separator component are typically supplied in powder form, in which case they are often referred to as having 100% active substance (AS) in the delivery state. However, these powders are mixed with certain quantities of a liquid, preferably water, before use in order to then apply the resulting dispersion to the surface of either the product produced, the mold, or both. In this dispersion or, depending on the embodiment, suspension, the powder component can also act as an agent that prevents or at least reduces the separation of the liquid phase and solid components, thus also acting as an agent for preventing the settling and/or generally the phase separation of the components of the dispersion/suspension. However, this usually requires that the dispersion/suspension be allowed to swell for a certain period of time, wherein the longer the swelling time, the better the effect of the mostly silicate solid component as an agent against phase separation and/or settling. This relationship applies until the point at which the swellable components of the dispersion/suspension have reached their maximum specific swelling capacity.

Even though such a processing aid can be potentially beneficial, especially because the separator component, which is based on an inorganic phase, reacts very little, if at all, with the organic components, for example of the product made from or comprising a polymer, such as for example rubber/caoutchouc, such processing aids, comprising powdered, in particular inorganic additives, such as for example silicates, in particular layered silicates, can be disadvantageous.

For example, it cannot always be ruled out that these powdered components may contain undesirable silicate phases, such as respirable SiO₂ or components that are similarly harmful to health, or alternatively or additionally so-called “rubber poisons” such as Cu and/or Fe³⁺ or substances that are undesirable for environmental reasons, such as barium. Furthermore, if used improperly, it is possible that processing aids comprising a powder component can only be applied unevenly, so that the applied release film forms agglomerates after drying, which, especially if they consist mainly of the inorganic components, can also form very hard residues that can also be difficult to remove. If such a processing aid comprising a powder component is partially incorporated into the product itself after improper use of the processing aid, in particular the inorganic component, this may lead to the formation of undesirable defects in the product itself, but also on the surface of the product, due to such hard residues. Alternatively or additionally, provided that improper use has occurred, such residues may also form on components of the production equipment, for example in a form that can also lead to stubborn adhesions.

It may therefore also be potentially beneficial to use liquid processing aids, such as a demolding agent or release agent, and/or formulations. Although these have a significantly lower concentration of active substance in the delivery state compared to processing aids, which comprise at least one powder component, but they only require a specific dilution step for use and no further special preparation such as swelling times, as described above for processing aids which preferably comprise a separator component based on an inorganic phase. Metal soaps may be a beneficial component of these liquid processing aids. These metal soaps act as separating body or spacer by adhering to the surface of, for example, products made of or comprising rubber mixtures and/or made of or comprising other polymers, thereby preventing the products from adhering to each other or to molds. However, there is a need for such processing aids that can be produced in the most environmentally friendly way possible, for example using a renewable raw material.

Disadvantages of prior art processing aids therefore lie partly in their performance, for example in the formation of residues on the produced product and/or, where applicable, on the molds used to manufacture it. This applies in particular to agents which, however, are particularly environmentally friendly, i.e., can be transported with a particularly high concentration of active substance (also abbreviated as “AS” in the context of the disclosure). Another disadvantage here is that powdered processing aids tend to form dust and may therefore also be unfavorable from a health perspective. In addition, the preparation of these agents prior to use, i.e., dispersing/suspending and, if necessary, swelling, represents an additional effort. Liquid processing aids and/or formulations, i.e., formulations with a high water content of, for example, more than 10% by weight of water and up to 85% by weight of water, for example up to 90% by weight of water or even up to 95% by weight of water, in each case based on the total weight of the formulation, do not have these disadvantages, but the concentration of active substance in these is generally significantly lower, which is unfavorable from an environmental point of view, for example. This is because the weight of a component that is only of minor importance for the performance of the processing aid is transported in this way.

At the same time, it may be taken into account that the processing aid according to the present disclosure, i.e., one which in particular has a separating effect, is only one of the processing aids generally used in the production of polymers, in particular organic polymers. It is therefore potentially helpful, as already discussed above with regard to the prior art, that the processing aid used does not influence the properties of the product to be produced, is preferably removable without leaving any residue and/or can be incorporated into the product or at least be present in part in the product to be produced without any loss of performance and/or changes in the properties of the polymer to be produced or the produced polymer. Therefore, when existing processing aids are reformulated, it is ensured that new components do not interfere with the manufacturing process of the actual product, but are inert with respect to the properties of the product to be produced, which is preferably a polymer.

It is also often disadvantageous to send prefabricated processing aids to the respective end users. This is because, as explained above, ready-made processing aids can settle, for example, or it is disadvantageous that only a small percentage of the “active substance” is delivered. In addition, different users will usually have implemented different processes for using a processing aid in the respective processes, so that there is a need to provide a processing aid that can be flexibly adapted to the needs of the end users.

There is therefore a need for improved processing aids, in particular processing aids with a separating effect, which do not tend to form residues, are beneficial from a health perspective, and yet enable use that is as environmentally friendly as possible, preferably without causing any changes in the product properties of the product produced using the processing aid.

The object of the present disclosure is to provide a formulation for producing a processing aid which reduces or at least mitigates the aforementioned limitations and/or deficiencies of the prior art and/or overcomes them at least in part. Further aspects relate to a method for producing a processing aid from the formulation and to the processing aid itself.

### SUMMARY

The object of the present disclosure is achieved by the subject-matter of the independent claims. Preferred and specific embodiments will be apparent from the dependent claims and the description of the present disclosure.

The present disclosure thus relates generally to a formulation for producing a processing aid. The formulation is preferably provided in powder form and, in particular, can be easily converted into a processing aid by the end user. Preferably, the formulation can be used to obtain an aqueous processing aid, i.e., one that comprises water as a liquid component. The formulation comprises a biopolymer, preferably a lignin and/or a lignin derivative, particularly preferably a lignin sulfonate, and at least one surfactant and/or a blend of at least two surfactants.

In the context of the present disclosure, a formulation (also: “preparation”) is understood to mean a mixture of substances, which can be converted into a processing aid by the addition of at least one further component, preferably a liquid component, in particular an aqueous component. It therefore represents a kind of “intermediate product” or “semi-finished product” in the production of a processing aid.

The processing aid is primarily used in the manufacture and/or further processing of organic polymers, such as rubber compounds, elastomers or other polymers. Where polymers are mentioned in the context of this disclosure, this refers in particular to organic polymers, wherein polymers including silicones or organopolysiloxanes (also known as silicone rubber or silicone elastomers) may also be included in the term organic polymer.

In the context of the present disclosure, it is generally understood that the processing aid and the formulation differ in the concentration of the active substance. In particular, the formulation may be in powder form and the processing aid may be in the form of a dispersion/suspension. Where reference is made to the formulation in the disclosure, the statements also apply mutatis mutandis to the processing aid and vice versa, unless the context expressly indicates otherwise, as is the case, for example, with the application of a release agent film and its effect, which refer explicitly to the processing aid and not to the formulation. If reference is made to the components and their contents, it is understood that these refer to the active substance content of the processing aid (i.e. without additional liquid, in particular aqueous, phases). The same applies to the formulation itself, which ideally consists purely of active substance and, if necessary, only contains small amounts of, for example, adsorbed liquid such as absorbed water. This means that the components listed in the formulation refer to the active substance, usually expressed as a percentage by weight based on the active substance content, which is made up of the components additive(s) (if present), metal soap(s) (including water-soluble soaps and/or water-insoluble metal soaps, depending on the exact composition of the corresponding formulation and if present), surfactant(s), biopolymer and, if applicable, separator component(s). The basic components of the active substance within the context of the disclosure are at least one surfactant and one biopolymer.

In the context of the present disclosure, a biopolymer is understood to be a naturally occurring organic polymer or a derivative thereof, preferably extracted or extractable from plant components. In particular, lignin and lignin derivatives, especially lignin sulfonate(s), are referred to as biopolymer(s) in the context of the present disclosure.

As discussed above, a biopolymer within the meaning of this disclosure is therefore preferably a renewable, natural raw material which, for example, in the case of a biopolymer composed of or comprising lignin or a lignin derivative, such as a lignin sulfonate, can be obtained from wood waste.

Lignin generally refers to an amorphous, resinous substance that occurs naturally as a component of wood and, to a lesser extent, sometimes also in grasses or herbaceous plants. Chemically, it can be described as a biopolymer and ultimately as a collective term for a series of macromolecules that are a component of plant cell walls, especially those of trees. The macromolecules have molecular masses of up to 11,000, particularly between 5,000 and 10,000 (which approximately corresponds to a molar mass between 5,000 g/mol and 10,000 g/mol) and comprise phenylpropane units, two particularly relevant of which are shown in FIG. 1. These phenylpropane units can be linked to each other via ether bridges, but also directly via carbon atoms. Possible substituents of the benzene ring of the structure can be common groups, such as one or more hydroxyl groups, one or more methoxy groups, rest chains, for example alkoxy chains, and the like. Lignin, for example, is a residue from the technical extraction of cellulose from wood.

Furthermore, a lignin sulfonate or lignosulfonate is generally understood to be a salt of lignin sulfonic acid. Lignin sulfonic acid itself is a derivative of lignin and can be obtained in particular by reacting lignin with sulfurous acid HSO₃. Like lignin itself, lignin sulfonate is not chemically precisely defined.

Despite the uncertainty regarding the exact chemical composition of this biopolymer, lignin and its derivatives are used in industry and are therefore known as such to the skilled person.

In the context of the present disclosure, a surfactant is understood to be a substance that generally reduces the surface tension of a liquid or—more generally—the interfacial tension between two phases. These are usually organic molecules that have a hydrophobic and a hydrophilic component. The hydrophobic part is often a hydrocarbon rest, for example a long alkyl chain, and is generally non-polar or unpolar; the hydrophilic part is generally polar and can be ionic, for example, but this is not necessarily the case. For example, a hydroxyl group can also form the polar part of the surfactant. Preferably, surfactants in the context of the disclosure have a molar mass of at most 10,000 g/mol, particularly preferably in the case where the surfactant and/or the mixture of at least two surfactants is formed from anionic surfactants or comprises such surfactants.

In the context of the present disclosure, metal soaps generally refer to salts of carboxylic acids, including salts of fatty acids, resin acids, and naphthenic acids, with metals. Metal soaps can be divided into water-soluble and water-insoluble types. Water-soluble metal soaps are often referred to simply as soaps. This applies in particular to water-soluble fatty acid salts with sodium and potassium ions.

A fatty acid is generally understood to be a mostly unbranched aliphatic monocarboxylic acid. Resin acids are a heterogeneous group of organic acids that occur, for example, in natural resins. Naphthenic acids are understood here as carboxylic acids comprising at least one cyclopentane and/or cyclohexane group with at least one alkyl substituent. These groups of carboxylic acids can also be referred to generally as “soap-forming carboxylic acids” in the context of the present disclosure.

In the context of the present disclosure, a water-soluble metal soap is understood to mean an alkali salt of one of the aforementioned carboxylic acids, in particular a sodium and/or potassium salt of one of the aforementioned carboxylic acids, i.e., for example, a fatty acid, or a mixture of these substances. The water-soluble soap may also be referred to as an alkali soap. In particular, the term water-soluble soap comprises a sodium and/or potassium salt of a fatty acid, for example a sodium and/or potassium stearate and/or a sodium and/or potassium oleate or mixtures thereof.

Preferably, a water-insoluble metal soap within the meaning of the disclosure comprises an alkaline earth metal, in particular calcium or magnesium.

Stearates belong to the group of metal soaps and, in the context of the present disclosure, represent the salts of selected fatty acids. In the context of the present disclosure, a stearate is in particular understood to generally mean salts of the alkanoic acids margaric acid, palmitic acid, and/or stearic acid. A stearate thus comprises a salt of hexadecanoic acid (n-hexadecanoic acid) and/or heptadecanoic acid (n-heptadecanoic acid) and/or octadecanoic acid (n-octadecanoic acid) and/or mixtures thereof. Preferably, a stearate within the meaning of the disclosure comprises as its main component a salt of octadecanoic acid, it being understood that at least 10% by weight, preferably at least 20% by weight and preferably more than 50% by weight of the stearate is in the form of a salt of octadecanoic acid. The alkanoic acids contained in stearate are mostly used in combination with different metals such as calcium, zinc, magnesium, sodium, aluminum, and lithium. These are referred to as calcium stearate, zinc stearate, magnesium stearate, sodium stearate, aluminum stearate, and lithium stearate, among others. In addition to calcium stearate, technical grade calcium stearate can often contain other calcium salts of higher fatty acids, such as calcium palmitate. This also applies accordingly to the other metal stearates.

The formulation according to the disclosure, i.e., comprising a biopolymer and at least one surfactant or a mixture of at least two surfactants, has a number of benefits. First, such a formulation, which can be delivered as a ready-to-ship product, is very easily suitable for reproducible conversion by an end user into a processing aid, preferably an aqueous processing aid, tailored to their specific needs. At the same time, the formulation can be expediently shipped as a solid, especially as a solid powder. Aging processes such as the settling of solid components, for example in a dispersion or suspension, do not occur. The end user is therefore flexible in setting the desired or processing viscosity of the processing aid, which he can adjust himself according to his processes and the machines used. But the formulation and the resulting processing aid also offer a number of other benefits over the prior art as well.

As stated, the formulation is preferably provided in powder and/or granulate form and can be easily converted into a liquid processing aid (as a dispersion/suspension). In other words, the formulation is preferably provided as a powder and/or granulate and thus comprises 100% active substance in this preferred embodiment, but at the same time is very easily convertible into the liquid application state. The term “liquid” is understood here to mean in particular the presence in a dispersion or suspension.

A particular potential benefit is that the formulation can be composed in such a way that a separator component based on an inorganic phase can be dispensed with. In this case, when converting into a processing aid by adding a liquid, preferably water or an aqueous liquid, it is then not necessary for the suspension/dispersion to “swell.” The processing aid or formulation according to embodiments of the disclosure is thus substantially more user-friendly. In its simplest form, as described, it comprises only a biopolymer, for example a lignin and/or a lignin derivative, particularly preferably a lignin sulfonate, and at least one surfactant and/or a mixture of at least two surfactants. Accordingly, the resulting processing aid is preferably in an aqueous phase, whether as a dispersion, suspension, or solution, comprising as active substance only a biopolymer, such as a lignin and/or a lignin derivative, for example lignin sulfonate, and at least one surfactant and/or a mixture of at least two surfactants. In general, the processing aid can therefore be understood and/or described according to embodiments as comprising water and an active substance, wherein the active substance may generally comprise water-soluble and/or water-insoluble components. For the sake of simplicity, the term “dispersion” is generally chosen in the following, wherein the mixture of substances as described above is to be understood, as explained. Although the simplest form of the processing aid according to embodiments as described comprises only a biopolymer and a surfactant and/or a mixture of at least two surfactants as the active substance, it can perform the function of a processing aid. Surprisingly, it has become apparent that a suitable biopolymer, such as lignin and/or a lignin derivative, such as lignin sulfonate, can take over the functionality of, for example, silicates, which are used in processing aids comprising a separator component based on an inorganic phase. A potential benefit here is that, even if used improperly, the processing aid or formulation according to the disclosure does not leave any hard dry residues. Exposure to potentially health-hazardous dusts can also be preferably completely eliminated or at least minimized in this way.

In the context of this disclosure, environmentally friendly use and/or an environmentally friendly product, such as a formulation and/or a processing aid, are understood to mean a use or a product which, compared to conventional processes, brings about an improvement in a process from a sustainability perspective, in particular with regard to resource conservation, for example, a lower shipping weight (less CO₂ emissions during shipping per unit of active substance used or per unit of processing aid used) and/or the use of renewable raw materials in the processing aid/formulation and/or better environmental compatibility in the degradation of the product and/or similar. In particular, enabling environmentally friendly or more environmentally friendly use is understood to mean that a processing aid or a formulation can be used for its manufacture which comprises a renewable, natural (or naturally occurring) raw material, as for example a biopolymer.

This is possible in the present case in particular because, as explained above, lignin sulfonate is a biopolymer, i.e., a renewable, natural raw material that can be obtained from wood waste, for example. Consequently, a lignin-comprising processing aid, such as a demolding agent, is preferably completely biodegradable, at least in specific embodiments. This is particularly relevant in the case of a processing aid for a rubber compound that is used to manufacture a vehicle tire, where the degradability of tire abrasion is also a priority. In this case, nothing of the processing aid remains.

Another benefit of using a biopolymer, in particular lignin and/or one or more lignin derivatives, for example lignin sulfonate, is that such a biopolymer, especially in the case of a lignin-comprising or lignin-based biopolymer, can be obtained inexpensively, since it is obtained, for example, as a residue from certain work processes in wood processing. In particular, it is also possible to use such residues, at least in part, in a processing aid or a formulation for producing a processing aid according to embodiments of the disclosure. A biopolymer made from or comprising lignin and/or at least one lignin derivative, such as lignin sulfonate, is particularly potentially beneficial in the formulation or processing aid according to embodiments because lignin or lignin derivatives, such as lignin sulfonate, have certain surfactant properties, i.e., they potentially reduce the surface tension of the resulting processing aid, which is an attractive side effect of the use of lignin or a lignin derivative, such as lignin sulfonate.

However, it has become apparent that the biopolymer alone, even in the form of a lignin-based biopolymer, i.e., consisting of or comprising lignin and/or a lignin derivative, for example consisting of or comprising lignin sulfonate, i.e., as the sole active substance of a processing aid or as the sole component of a formulation for the production of such a processing aid, does not work, i.e. a simple coating, for example, of a rubber or polymer surface or, more generally, of a surface of an organic polymer with a biopolymer powder or with an aqueous solution of a biopolymer, also in the form of a biopolymer, which, as above, is lignin-based, i.e. comprises lignin and/or at least one lignin derivative, for example lignin sulfonate, does not form a film or layer that leads to a satisfactory separating effect. However, it has become apparent that this is possible if a certain amount of surfactant is added to the biopolymer. Therefore, in addition to a biopolymer, preferably lignin and/or a lignin derivative, particularly preferably a lignin sulfonate, the formulation comprises at least one surfactant and/or a mixture of at least two surfactants.

The inventors suspect that this is because the biopolymer, for example in the form of lignin or for example in the form of the derivative lignin sulfonate, becomes more hydrophobic as its molar mass increases, which means that the surfactant properties of lignin sulfonate in the processing aid are insufficient to wet the desired surfaces. Thus, a certain amount of surfactant appears to be beneficial in addition to the biopolymer to ensure that the contact of the biopolymer molecule, for example in the form of a lignin sulfonate molecule or several biopolymer molecules, such as lignin sulfonate molecules, to the respective surface between which the separating film is to separate, can be ensured.

Surprisingly, it has become apparent that the interaction between biopolymer, especially when in the form of lignin and/or lignin derivative such as lignin sulfonate, and stearate produces a flexible film that consists of a highly lubricating component (stearate) and a stabilizing part, which presumably forms an interconnected weave (biopolymer, e.g., lignin and/or lignin derivative). In the case of the biopolymer being present as a lignin-based biopolymer (i.e., comprising lignin and/or at least one lignin derivative, such as lignin sulfonate), this occurs surprisingly in the presence of stearate and surfactant, regardless of the natural source of the lignin (softwood or hardwood). Independent thereof, the functionality of the processing aid resulting from the formulation is very high in this case.

In particular, the use of lignin sulfonate is preferred therein. In other words, the biopolymer according to one embodiment of the disclosure is generally configured so that it preferably comprises lignin sulfonate or is formed from lignin sulfonate.

Lignin sulfonates are known to be capable of influencing surface and interfacial tensions to a certain extent, in particular reducing them. Lignin sulfonates are therefore also known as bio-based so-called “surfactants” and specialty chemicals. However, it is also known that the so-called interfacial tension/interfacial energy of lignin sulfonates is much higher than that of other commercially available surfactants.

It is generally known that biopolymers can be regarded as an arrangement of structural units in statistical distribution rather than as a phase/molecule with a strictly defined chemical structure in the classical sense. This also applies, for example, to lignin and lignin derivatives such as lignin sulfonate. Lignin sulfonates within the meaning of the present disclosure have a polydisperse structure and molecular weights of 1,000-400,000 g/mol. The basic building blocks of lignin and, accordingly, of lignin derivatives such as lignin sulfonate are shown in an illustrative manner in FIG. 1, which will be discussed in more detail below.

The properties of lignin and its derivatives, such as lignin sulfonate as a particularly preferred example of a biopolymer, described below result from the large number of so-called H, G, and S structural units that form the functional groups within, for example, a lignin sulfonate composition. These structural units can be divided into ionizable, polar, and nonpolar structural units.

These structural units and their specific arrangement can then be responsible, for example, for amphiphilicity, i.e., amphiphilic properties, or anionic (sulfonate and carboxyl group) properties, while less polar groups, i.e., aromatic and aliphatic rests, facilitate interactions with surfaces and interfaces.

However, their structure does not exhibit the one-dimensional “hydrophilic head-hydrophobic tail” configuration found in simpler surfactants.

For applications in aqueous phases, the hydrophilicity of lignin sulfonates is potentially helpful when the biopolymer is formed from lignin sulfonate, for example, formed purely from lignin sulfonate, or when it comprises lignin sulfonate. However, the simultaneously present hydrophobic property of lignin sulfonates facilitates interactions with non-aqueous phases. The literature describes that, depending on the application, the ratio between hydrophobic and hydrophilic properties should be adjusted, which in turn is determined by the chemical composition and structure.

However, in the course of the work underlying the present disclosure, it has been found that, in combination with a surfactant and preferably a stearate, the ratio of hydrophobic and hydrophilic properties of, for example, a lignin sulfonate plays a helpful but rather minor role for the function of a processing aid. Even though the presence of ionic functional groups of polymers in the context of electrostatic interactions with the anionic groups of the lignin sulfonates could lead to something like adhesion, the experiments carried out for the present disclosure have shown that a surfactant additive to a lignin sulfonate is beneficial in order to ultimately produce, also in an aqueous phase, an affinity and a separating film adhering to a polymer surface, in particular a rubber surface, from a lignin sulfonate-comprising processing aid according to the disclosure.

According to one embodiment of the present disclosure, for that a resulting surface tension of the processing aid of less than 50 mN/m, preferably less than 40 mN/m and particularly preferably less than 30 mN/m is helpful, which in particular cannot be achieved without the addition of surfactant, since, for example, aqueous dispersions of or comprising lignin sulfonate typically have a surface tension of 60 mN/m or more.

Only in the presence of a surfactant to the lignin sulfonate, or more generally to a biopolymer, a separating film is formed from the large and widely branched lignin sulfonate molecules, or more generally, the molecules of the biopolymer, whose structure can be described as a geometric arrangement of mosaic-like areas with intermediate areas and which therefore exhibits high flexibility with regard to geometric changes in the substrate while at the same time providing sufficient mechanical stability to ensure a separating effect.

In particular, it has become apparent that this effect is potentially beneficially also present for such polymer mixtures, for example elastomer mixtures such as rubber mixtures, to which sulfur compounds have been added as crosslinking agents, and that the processing aids according to the present disclosure can be used potentially beneficially here.

Although biopolymers, as for example lignin or its derivatives, as for example lignin sulfonates in general, also have a polymeric structure and could therefore theoretically be used in the formation of rubber or other polymer products such as elastomers, or be incorporated into them, it has shown that a formulation and ultimately a processing aid according to the disclosure does not lead to a change in the polymer properties. This was investigated extensively in detail for the case of the biopolymer lignin sulfonate. Although the typical structure of lignin sulfonate comprises SO₃⁻ structural units, these are respectively provided in such a way that they do not interfere with the production process of elastomers, rubber, or polymer, presumably in particular because the amount of processing aid used is so small that transfer into the corresponding elastomer, rubber or polymer in general is not relevant for the formation of its relevant product properties. This ensures that in all further processing steps of the manufactured product, any such possible transfer of the processing aid into the manufactured product acts merely as a passive processing aid and does not adversely affect the properties of the manufactured product.

Another benefit of processing aids according to the disclosure is that such processing aids have been shown to dry faster, i.e., for example, the release agent film formed on the product formed from or comprising a rubber mixture and/or other polymer dries faster. The inventors assume that this is because the biopolymer, for example lignin and/or a derivative thereof, such as lignin sulfonate, unlike other components of processing aids known from the prior art, in particular those which have a separating effect, does not absorb additional water. The drying of, for example, a release agent film generally takes place via the heat of the product made of or comprising a rubber compound and/or another polymer. Here, the processing aid according to embodiments can be potentially beneficially used in such processes for the manufacture of products formed from or comprising a rubber mixture, an elastomer, a rubber and/or another polymer, which is produced in rather “colder” processes, since (shorter) drying times can then be achieved, which were previously only possible in rather “warmer” processes.

Lignin or a derivative of lignin as a component of a processing aid (in the form of an anionic, lignin-based surfactant) is known in principle. For example, Japanese patent JP 5579454 B2 describes that adding lignin to a stearate allows the stearate to be dispersed in water. However, the inventors were unable to reproduce this. Furthermore, the processing aid according to JP 5579454 B2 is based on a layered silicate, namely montmorillonite, as an essential component, so that different mechanisms may be at work here than those described in the present disclosure. As already explained, it has been shown that lignin sulfonate as such, together with a surfactant, is already capable of ensuring a sufficient demolding or, in general, separating effect. According to an embodiment, it can therefore be generally provided that the processing aid or the formulation for producing such a processing aid according to the disclosure is free of a powder component, in particular an inorganic powder component, in particular free of a silicate, for example a layered silicate. However, it is generally possible that the formulation or, accordingly, the processing aid produced from the formulation comprises a powdery, for example inorganic, component, although this embodiment is not preferred. Preferred is a design in which the processing aid or the corresponding formulation does not comprise any inorganic components, in particular no separator component based on an inorganic phase.

According to one embodiment, the processing aid or the formulation for its production comprises at least one water-insoluble metal soap, preferably a stearate, particularly preferably a stearate of at least one alkaline earth metal, preferably a magnesium and/or calcium stearate or mixtures thereof. The inventors have found that the formation of a flexible and mobile separating film, for example, is achieved potentially beneficially in such a composition, so that the separating effect or the formation of a uniform separating film is particularly easy to achieve in this way. In particular, it has become apparent that in embodiments with a water-insoluble metal soap, such as a stearate of an alkaline earth metal, as a component of the processing aid or correspondingly of the formulation, surfaces with a particularly high lubricating effect, i.e., particularly low static friction of the surfaces, are formed. It is assumed that this lubricating effect is related to or based on this water-insoluble metal soap component or can be potentially beneficially supported by it, whereas the biopolymer component (in particular consisting of or comprising lignin and/or a lignin derivative, such as lignin sulfonate) forms an interconnected network, i.e., for example, gives structure to a film formed from the processing aid. Furthermore, it is precisely in the combination of the three aforementioned components of the preferably aqueous processing aid or in the corresponding formulation, i.e. here comprising a biopolymer, preferably in the form of a lignin-based biopolymer, for example comprising or consisting of lignin sulfonate, a surfactant and at least one stearate, that an excellent release or, if necessary, demolding effect is obtained. It appears that this allows a particularly uniform, well-adhering, but also easily washable film to be obtained, which has a good separating effect, so that the processing aid can be used, for example, for demolding and/or as a release agent.

According to a further embodiment of the processing aid or the formulation, the biopolymer is or comprises lignin sulfonate, wherein the lignin sulfonate is or comprises an alkali and/or alkaline earth lignin sulfonate, wherein an alkali and/or alkaline earth lignin sulfonate is understood in particular to mean a sodium, calcium, magnesium and/or ammonium lignin sulfonate and/or mixtures thereof, with a sodium lignin sulfonate being particularly preferred. This has enabled particularly good results to be achieved in terms of separation effect, in addition, this way a stable processing aid is obtained that is easy to apply and does not tend to separate, for example into a liquid phase and settled solid components, even when used in the form of a dispersion or suspension. Furthermore, especially the lignin sulfonates of the alkali and alkaline earth metals mentioned, wherein ammonium is also understood here as an alkali, since it belongs to the “soluble group” in chemical analysis like the alkalis themselves, are very water-soluble and therefore particularly preferred here for the reasons mentioned above.

According to one embodiment, the processing aid or the formulation for its production comprises at least 20% by weight, preferably at least 35% by weight, and at most 90% by weight of a biopolymer, preferably of lignin or a lignin derivative, preferably of a lignin sulfonate, preferably between 50% by weight and 70% by weight of a biopolymer, preferably of lignin or a lignin derivative, preferably of a lignin sulfonate.

This embodiment is potentially beneficial, because it ensures that the processing aid or the corresponding formulation for producing the processing aid comprises the highest possible proportion of renewable raw material, namely at least 20% by weight, preferably at least 35% by weight, and up to a maximum of 90% by weight of a biopolymer, preferably lignin or a lignin derivative, preferably a lignin sulfonate, preferably an alkali and/or alkaline earth lignin sulfonate in the sense of the disclosure, and/or mixtures of these lignin sulfonates. In particular, the lignin sulfonate may be or comprise sodium lignin sulfonate. Further preferred limits are at least 50% by weight and at most 70% by weight.

As already discussed in detail above, lignin sulfonate acts in a preferred embodiment as a helpful component of the processing aid or the corresponding formulation for its production and, for example, when the processing aid is used appropriately, ensures the formation of a stable but flexible release film on a substrate, such as a mold and/or the product itself, for example a rubber, a rubber mixture or, in general, an (organic) polymer or elastomer. As explained, the biopolymer itself, such as lignin, either as such and/or in the form of a derivative, such as lignin sulfonate, does not react with the polymer product, which is primarily composed of organic components, but rather, when the processing aid is applied to the polymer product, for example in the form of a release film, it merely forms a physical bond with the polymer product, which can be easily released again, where applicable, thus if necessary. However, in the event that components of the processing aid or the formulation are transferred to the polymer product, the processing aid is, as already discussed above, contained in such a small proportion and is therefore also so inert that it does not influence the properties of the polymer product, which can therefore be processed and further processed as usual. In order to achieve a sufficient separating effect in general, regardless of the exact application, the proportion of the biopolymer, for example lignin or a lignin derivative, such as lignin sulfonate according to a preferred embodiment, in the processing aid or the corresponding formulation for its production may therefore be at least 20% by weight. The proportion is at least 35% by weight, for example at least 50% by weight.

However, it may also be potentially beneficial not to choose too high a proportion of the biopolymer, for example a lignin sulfonate and/or a lignin or other lignin derivative. In particular, the proportion may preferably not exceed 90% by weight. It has shown that the biopolymer, such as lignin sulfonate or lignin in general and/or one of its derivatives, as such does not interfere with the manufacturing process of the products to be separated, either itself or in the form of a derivative. However, as also already explained above, it has shown that a biopolymer, for example lignin sulfonate, is not sufficient as the sole active substance, but rather that at least one further component is included in the processing aid (and accordingly in the formulation for its production), in particular a surfactant. Therefore, the proportion of the biopolymer, for example a lignin sulfonate, in the demolding agent according to embodiments is at most 90% by weight, preferably at most 70% by weight.

According to a further embodiment, the processing aid or the corresponding formulation for its production comprises between at least 5% by weight and at most 25% by weight of a surfactant and/or a mixture of at least two surfactants. Where reference is made below to the content of the processing aid or the formulation in terms of surfactant, this refers to the total surfactant content.

The nature of the surfactant or surfactants in the mixture is generally not particularly limited, but rather, it can generally be an ionic or nonionic surfactant. Mixtures of anionic and non-ionic surfactants are particularly preferred. According to one embodiment, the surfactant content may be at least 5% by weight in order to enable a reliable formation of a flexible separating film that is sufficiently immobilized on the surface of the product produced, as also explained above. However, the surfactant content may also not be too high, since the surfactant in the processing aid or the corresponding formulation according to embodiments is an auxiliary substance, which does not itself actively contribute to the separation of the surfaces, but merely ensures good film formation. 25% by weight therefore represents a preferred upper limit for this component, for example also for economic reasons.

The surfactant or mixture of surfactants can be such that the surfactant or mixture of at least two surfactants has an HLB value between 3 and 20, preferably between 6 and 18, particularly preferably between 6 and 15, wherein, in the case of a mixture, the HLB value refers to the resulting HLB value of the mixture. This ensures particularly good film formation. The HLB value is understood to be the HLB value determined according to William C. Griffin in the context of the disclosure.

According to a further embodiment, the processing aid or the corresponding formulation for producing a processing aid comprises, as a further component, up to and including 20% by weight of at least one water-soluble soap, preferably up to and including 10% by weight. It is generally understood here that the processing aid may comprise at least one water-soluble soap or a mixture of water-soluble soaps, wherein the specified content of at most 20% by weight or at most 10% by weight refers to the total content in the case that the demolding agent comprises more than one water-soluble soap.

It is generally understood that the processing aid or formulation according to embodiments may comprise at least one metal soap or a plurality of metal soaps. In general, the total content of metal soaps (i.e., water-soluble and/or water-insoluble metal soaps) may be up to 60% by weight, wherein this value refers to the total content of metal soaps. In general, within the context of the present application, an indication of the content of a component, if several of these components are present in the formulation and/or in the processing aid, refers to the sum of these components, i.e., for example, to the sum of the metal soaps comprised in the formulation/processing aid. For example, the content of water-insoluble metal soaps in the formulation may be at most 40% by weight, preferably between at least 15% by weight and at most 35% by weight, wherein this indication then refers to the total content of water-insoluble metal soaps, i.e. in the case that the processing aid or the formulation comprises more than one water-insoluble metal soap, the specified limits refer to the sum of the water-insoluble metal soaps comprised.

An example of a potentially beneficial water-insoluble metal soap or a group of water-insoluble metal soaps are stearates, in particular stearates of alkaline earth metals, in particular magnesium and/or calcium stearates or mixtures thereof. In particular, according to one embodiment, the processing aid or formulation may comprise up to 40% by weight of a stearate, preferably an alkaline earth metal stearate, preferably a magnesium and/or calcium stearate or mixtures thereof, preferably between at least 15% by weight and at most 35% by weight.

Water-soluble soaps may include, for example, stearates and/or oleates of sodium or potassium or a mixture thereof. Oleates are salts of oleic acid or olein acid.

According to a still further embodiment, the processing aid or the formulation for its production comprises at least one additive as an additional component, wherein the processing aid may comprise several additives, and preferably the content of additive or, in the case that the processing aid or the formulation comprises several additives, of additives is between 1% by weight and 3% by weight.

Additives are generally substances that can be added to a formulation or processing aid, such as a release agent or demolding agent, in order to improve or adjust certain properties. These may generally be known auxiliary substances, for example thickening agents, defoamers or similar components that are generally known to a person skilled in the art.

It is also possible that, according to one embodiment, the formulation or processing aid comprises at least one separator component based on an inorganic phase. However, this is not absolutely necessary for the processing aid according to embodiments of the disclosure, and particularly in environments where it is desirable to work as free of particles as possible, embodiments without a separating body element based on an inorganic phase may be preferred.

It is also possible that, according to one embodiment, the formulation or processing aid comprises at least one separator component based on an inorganic phase. Although, overall, this is not absolutely necessary for the processing aid according to embodiments of the disclosure, and particularly in environments where it is desirable to work as free of particles as possible, embodiments without a separator component based on an inorganic phase may be preferred.

However, it has been generally shown that the use of a biopolymer, such as lignin or lignin sulfonate, in combination with an inorganic powder component or with several such powder components can also be beneficial. In this way, as can be seen, for example, in a scanning electron microscope, a “very thick” separating film is obtained, which is understood to mean a thickness in the single-digit micrometer range, for example up to 2 μm or up to 1 μm. Regardless of the thickness of the separating film, the separating films according to the present disclosure are visible or at least become visible during use. As described above in relation to known processing aids comprising such inorganic powder components, these often require a so-called swelling time in order to develop their demolding effect optimally and at the same time stabilize the dispersion by effectuating thickening and thus counteracting phase separation, for example settling. This applies in particular to so-called layer silicates, such as talc and/or bentonite.

It has been generally shown that, in general, a biopolymer such as, for example, lignin or a lignin derivative such as lignin sulfonate, in particle-based compositions of a processing aid not only surprisingly reduces its viscosity, which may be beneficial, for example, for uniform and thin application, but that such processing aids comprising a biopolymer such as lignin and/or a lignin derivative such as lignin sulfonate, in particular within the limits specified in the embodiments of the disclosure, also counteract settling. This is particularly surprising because the biopolymer used here, for example lignin and/or a derivative of lignin such as lignin sulfonate, actually per se reduces the viscosity of the resulting processing aid, as explained above. Another benefit is that, unlike known inorganic powder components, the biopolymer does not require a swelling time to develop its stabilizing effect. This is potentially beneficial in embodiments of the biopolymer comprising lignin and/or a lignin derivative, such as lignin sulfonate, so that such embodiments of the formulation or processing aid are particularly preferred. Furthermore, it has also been shown that residues containing lignin, which can arise during improper use, are washable and can therefore be removed very easily and with little effort, for example from a mold, if necessary. In the combination of lignin or a lignin derivative, for example lignin sulfonate, and an inorganic powder component, there may be synergistic benefits, since, for example, a lower proportion of an inorganic powder component can be used and this can then also be cleaned off more easily in cases where this is desirable for technical reasons due to the overall good washability of the lignin content.

Preferably, the processing aid or the formulation for its production according to this embodiment may comprise up to 50% by weight of a separator component which is based on an inorganic phase or of a mixture of separator components which are based on an inorganic phase, preferably of a layered silicate or of a mixture of powder components.

The formulation may be essentially water-free, which means that the formulation comprises water only in the form of unavoidable residual amounts, for example in the form of adsorption-bound water. Such unavoidable residual amounts are present in a maximum of 15% by weight, preferably a maximum of 10% by weight, and particularly preferably a maximum of 5% by weight, based on the weight of the formulation. However, higher water contents are also possible, in which case the transition from a formulation to a processing aid is fluent and defined by the value of the ready-to-use delivery form or concentration. However, it is also possible that the formulation comprises a liquid component in the form of a solvent, which may be different from water.

Surprisingly, it has been shown that a formulation consisting of a biopolymer such as lignin and/or a lignin derivative such as lignin sulfonate and a metal soap can also itself be used as a processing aid without the addition of water.

### EXAMPLES

The following lists an illustrative composition range for a formulation according to embodiments or a respective processing aid according to the present disclosure. For the processing aid, the specifications relate in particular to the active substance present in addition to the aqueous phase, in particular with regard to the content specifications. In particular, after conversion of the formulation into a processing aid, it may generally be an aqueous processing aid, which is generally understood to mean that the liquid component or solvent comprises water. All information is given here in % by weight.
Biopolymer more than 20, preferably at least 35% by weight, preferably no more than 90% by weight, particularly preferably at least 50% by weight and preferably no more than 70% by weight,
Surfactant(s) 5% by weight to 25% by weight,
Water-soluble soap(s) up to and including 20% by weight, preferably up to and including 10% by weight,
Water-insoluble metal soap(s) up to 40% by weight, preferably between at least 15% by weight and at most 35% by weight,
optional additive(s) if present, between 1% by weight and 3% by weight,
optional separator component(s) if present, up to 50% by weight,
wherein the biopolymer preferably is or comprises lignin or a lignin derivative, in particular lignin sulfonate.

As already explained above with regard to embodiments, the components may, in the case of the biopolymer, be, in particular, an alkali and/or alkaline earth lignin sulfonate, wherein an alkali and/or alkaline earth lignin sulfonate is understood to mean, in particular, a sodium, calcium, magnesium and/or ammonium lignin sulfonate and/or mixtures thereof, with sodium lignin sulfonate being particularly preferred.

As water-soluble soap or soaps, a stearate or an oleate or mixtures of one or more stearates or oleates or mixtures thereof in particular may be considered, for example up to a total of 20% by weight, preferably a sodium and/or potassium stearate and/or a sodium and/or potassium oleate or mixtures thereof, preferably up to and including 10% by weight.

As a water-insoluble metal soap, in particular a stearate or mixtures of stearates of alkaline earth metals, preferably a magnesium and/or calcium stearate or mixtures thereof, may be considered.

According to one embodiment of the processing aid and/or the formulation, it does not comprise any inorganic powder components.

The disclosure also relates to a method for producing a processing aid, comprising the following steps:
providing a formulation, in particular a formulation according to an embodiment,
providing a liquid, preferably consisting of or comprising water,
dispersing the formulation in the liquid to obtain a processing aid.

The disclosure therefore also relates to a processing aid produced or producible from a formulation according to an embodiment of the disclosure and/or in a method according to the disclosure.

### DESCRIPTION OF THE DRAWINGS

The present disclosure is described in more detail below with reference to figures. These show:

FIG. 1 an illustration of two basic building blocks of lignin, and

FIGS. 2 and 3 illustrative scanning electron microscope images of a separation film.

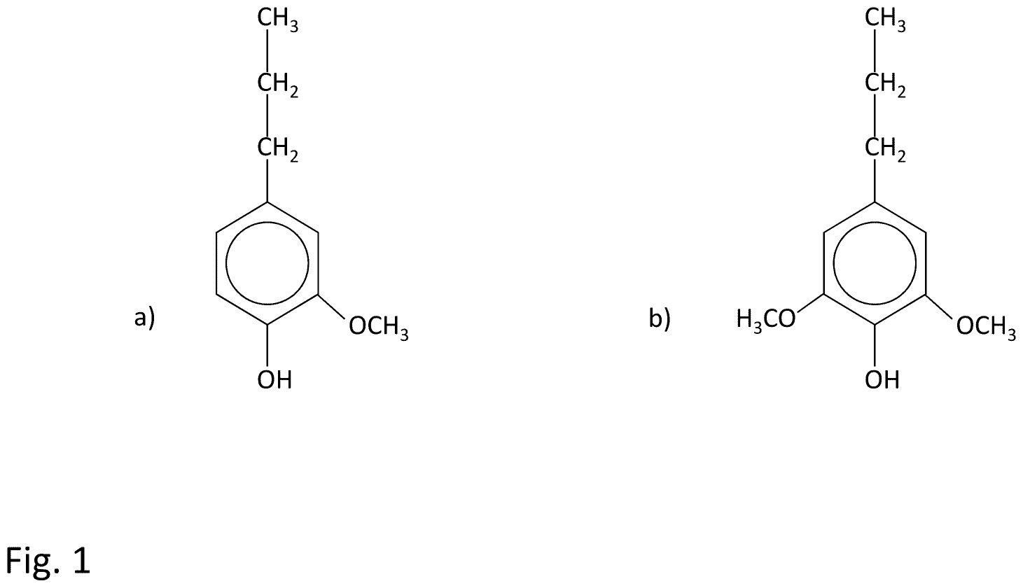

FIG. 1 a) shows the so-called “guajacyl unit” as an example of a phenylpropane unit, which is a basic building block of lignin. As can be seen, this structure comprises a benzene ring with a propyl chain (n-propyl) as a substituent, as well as a hydroxyl group and a methoxy group as further substituents of the benzene ring.

FIG. 1b) shows the so-called “syringyl unit,” another example of a phenylpropane unit as a possible basic building block of lignin. Here, the molecule comprises two methoxy groups, in contrast to only one in the molecular structure shown in FIG. 1a).

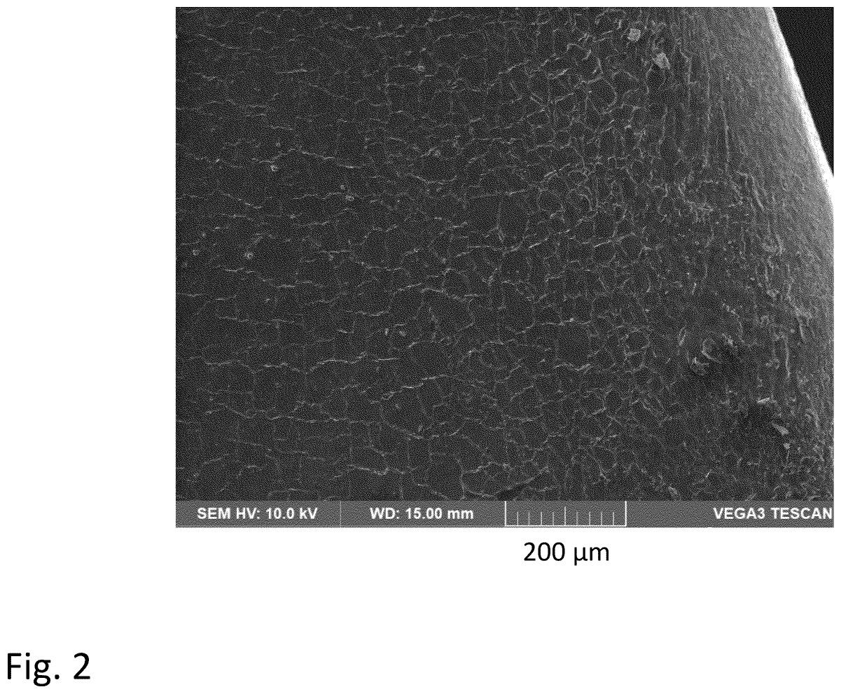

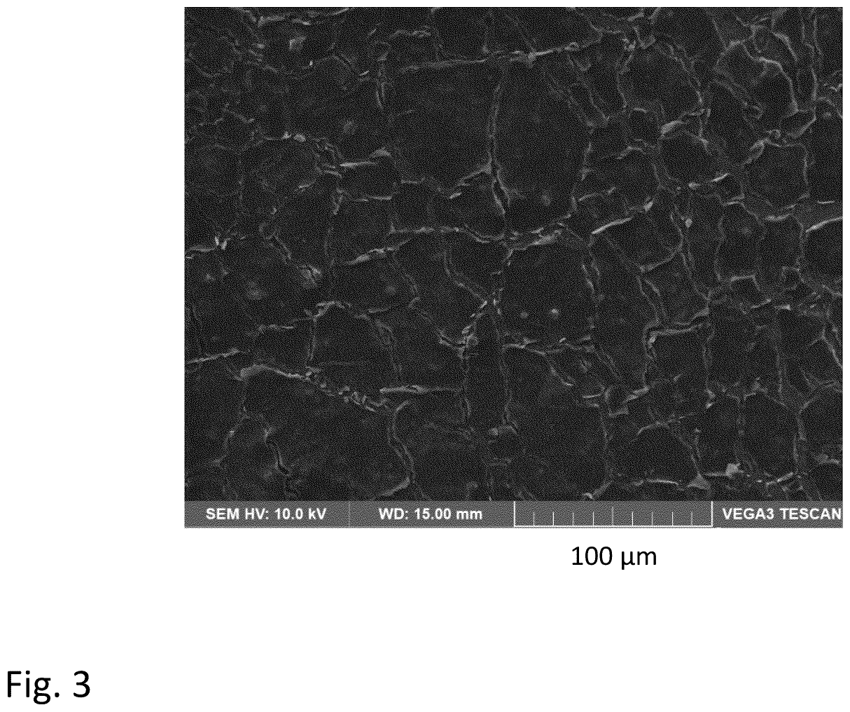

FIGS. 2 and 3 show illustrative scanning electron microscope images of a rubber surface which has been treated with a processing aid according to one embodiment, in this case coated. The scale is indicated in each case; FIG. 3 is an enlargement of the film according to FIG. 2. For the coating process, the processing aid, which in this case comprises a separator component which is based on an inorganic phase, was dispersed in water and the rubber surface was coated with the processing aid by immersion in the aqueous processing aid so that a surface film could form on the rubber surface.

As can be seen from the images in FIGS. 2 and 3, the rubber surface is almost completely coated. This means that the surface of the rubber cannot or can hardly come into direct contact with the surfaces of other materials. This ensures, among other things, that the rubber surface is passivated and, in addition/together with the spacers introduced in the processing aid (here, in addition to lignin sulfonate components, in particular a separator component which is based on an inorganic phase), a separating effect is achieved with other surfaces. The coating made of processing aid (i.e., the separating film) is permeated by lamella-like structures, so that the separating film has a mosaic-like structure in which the individual components of the film (tiles) are irregularly shaped but have a certain similarity in terms of size and distribution. This results in high flexibility of the separating film. This ensures that the absence of a single or a few mosaic components, which can be caused by damage, for example, does not lead to failure of the separating film. (Turtle shell-like pattern with high flexibility).

1. A formulation for producing a processing aid comprising a biopolymer, and at least one surfactant and/or a mixture of at least two surfactants.

2. The formulation according to claim 1, wherein the surfactant and/or the mixture of at least two surfactants has an HLB value between 3 and 20, wherein, in the case of a mixture, the HLB value refers to a resulting HLB value of the mixture.

3. The formulation according to claim 1, further comprising a water-insoluble metal soap.

4. The formulation according to claim 1, wherein the biopolymer is or comprises lignin sulfonate, in particular an alkali and/or alkaline earth lignin sulfonate, wherein an alkali and/or alkaline earth lignin sulfonate is understood to mean in particular a sodium, calcium, magnesium and/or ammonium lignin sulfonate and/or mixtures thereof.

5. The formulation according to claim 1, wherein the formulation comprises at least 20% by weight and at most 90% by weight of a biopolymer.

6. The formulation according to claim 1, wherein the formulation comprises between at least 5% by weight and 25% by weight of the surfactant and/or the mixture of at least two surfactants.

7. The formulation according to claim 1, comprising up to and including 20% by weight of at least one water-soluble soap.

8. The formulation according to claim 1, comprising up to 40% by weight of water-insoluble metal soaps.

9. The formulation according to claim 1, further comprising between 1% by weight and 3% by weight of additives.

10. The formulation according to claim 1, further comprising at least one separator component, which is based on an inorganic phase, and can be added as a powder component.

11. The formulation according to claim 1, comprising the following components in % by weight:
biopolymer more than 20% by weight, preferably at least 35% by weight,
preferably no more than 90% by weight, particularly preferably at least 50% by weight and preferably
no more than 70% by weight,
surfactant(s) 5% by weight to 25% by weight,
water-soluble soap(s) up to and including 20% by weight, preferably up to and including 10% by weight,
water-insoluble metal soap(s) up to 40% by weight
optional additive(s) if present, between 1% by weight and 3% by weight,
optional separator component(s) if present, up to 50% by weight,
wherein the biopolymer is or comprises lignin or a lignin derivative.

12. The formulation of claim 1, which does not comprise a separator component, which is based on an inorganic phase.

13. A method for producing a processing aid, comprising the steps of:
providing a formulation comprising a biopolymer, and at least one surfactant and/or a mixture of at least two surfactants,
providing a liquid, preferably consisting of or comprising water,
dispersing the formulation in the liquid to obtain a processing aid.

14. A processing aid, produced or producible from the method according to claim 13.

15. A processing aid, produced or producible from the formulation according to claim 13.

16. The formulation of claim 1, wherein the processing aid is an aqueous processing aid, and the biopolymer is a lignin and/or a lignin derivative.

17. The formulation of claim 16, further comprising:
a water-insoluble metal soap including a magnesium stearate, a calcium stearate, or mixtures thereof,
wherein the biopolymer is or comprises lignin sulfonate.

18. The formulation of claim 16, further comprising:
a water-soluble soap including a magnesium stearate, a calcium stearate, or mixtures thereof, and/or a sodium stearate, a potassium stearate, or mixtures thereof, and/or a sodium oleate, a potassium oleate, or mixtures thereof,
wherein the biopolymer is or comprises lignin sulfonate.

19. The formulation of claim 16, further comprising:
a water-insoluble metal soap including a magnesium stearate, a calcium stearate, or mixtures thereof, and
a water-soluble soap including a magnesium stearate, a calcium stearate, or mixtures thereof, and/or a sodium stearate, a potassium stearate, or mixtures thereof, and/or a sodium oleate, a potassium oleate, or mixtures thereof,
wherein the biopolymer is or comprises an alkali lignin sulfonate and/or an alkaline earth lignin sulfonate.

20. The formulation of claim 19, including
between 50% by weight and 70% by weight of the biopolymer,
between at least 15% by weight and at most 35% by weight of the water-insoluble metal soap,
up to 20% by weight of the water-soluble soap, and
between 1% by weight and 3% by weight of additives.
